(19) United States
(12) Patent Application Publication
(10) Pub. No.: US 2022/0001526 A1
(43) Pub. Date: Jan. 6, 2022

(54) POWER TOOL AND CONTROL METHOD

(71) Applicant: Nanjing Chervon Industry Co., Ltd., Nanjing (CN)

(72) Inventors: Pengchen Wang, Nanjing (CN); Hongwei Wang, Nanjing (CN); Jinbiao Zhao, Nanjing (CN); Yang Li, Nanjing (CN); Zhongquan Xu, Nanjing (CN); Huilong Zhou, Nanjing (CN)

(21) Appl. No.: 17/480,174

(22) Filed: Sep. 21, 2021

Related U.S. Application Data
(63) Continuation of application No. PCT/CN2020/082328, filed on Mar. 31, 2020.

(30) Foreign Application Priority Data
Apr. 4, 2019 (CN) 201910272338.5
Jun. 3, 2019 (CN) 201910474357.6
Sep. 30, 2019 (CN) 201910943076.0

(51) Int. Cl. B25F 5/00; H02K 7/14; H02K 11/28; H02K 11/33; H02K 7/116; H02P 3/06

(52) U.S. Cl. CPC B25F 5/001; H02K 7/145; H02P 3/06; H02K 11/33; H02K 7/116; H02K 11/28

(57) ABSTRACT

A power tool includes an output shaft, a motor, a housing, a detection unit, a storage device and a control unit. The output shaft is configured to output a torsion. The motor is configured to drive the output shaft to rotate. The housing is configured to accommodate the motor. The detection unit is configured to detect an operational parameter of the power tool. The storage device is configured to store at least a first threshold corresponding to a first operating condition set and a second threshold corresponding to a second operating condition set. The control unit is communicatively connected to the detection unit and the storage device.

### RELATED APPLICATION INFORMATION

The present application is a continuation of International Application Number PCT/CN2020/082328, filed on Mar. 21, 2020, through which this application also claims the benefit of Chinese Patent Application No. 201910272338.5, filed on Apr. 4, 2019, Chinese Patent Application No. 201910474357.6, filed on Jun. 3, 2019, and Chinese Patent Application No. 201910943076.0, filed on Sep. 30, 2019, which applications are incorporated herein by reference in their entirety.

### BACKGROUND

When using a torque output tool such as a drill or a screwdriver, users are faced with a lot of inconveniences. For example, when operating a power tool, the users start a switch to stop torque output of the power tool through artificially recognizing that a bottom surface of a screw head has touched a surface of a workpiece. Because a drilling breakthrough time is very short, the users often fail to react so as to control a speed regulation trigger to finish running of the drill in time. Therefore, an object behind is easily broken.

When using the drill or the screwdriver, the users also need to pay much attention to completion of work. When the screw is disengaged, slipped and breaks through the workpiece, the users needs to control and stop the drill or the screwdriver in time, and the energy of the users is consumed and the user often cannot control in time, thereby causing unnecessary damage.

In the related art, there are some designs with which rotation can be automatically controlled to stop when the workpiece is broken through or the screw reaches the bottom, but accuracy is not high, and a determination error often occurs, thereby bringing inconvenience to the users. Chinese patent CN107544426A discloses a control method for shutting down at a preset position under different operating conditions, which only shows how to acquire an average value and a slope value of parameters representing an output shaft load to interrupt the torque output of the power tool. However, for a practical application of a product, workpieces made of different materials matching different types of screws can produce dozens or even hundreds or thousands of different operating conditions. For example, wood workpieces made of different materials matching small, medium, and large screws can produce dozens or hundreds of operating conditions, metal workpieces made of different materials matching small, medium, and large types of screws can produce dozens or hundreds of operating conditions, and workpieces made of other different materials matching small, medium, and first-type large screws can produce hundreds or thousands of operating conditions. Each operating condition has a corresponding theoretical load threshold to determine whether the power tool has reached the preset position. For example, the bottom surface of the screw head at this preset position touches the surface of the workpiece. Chinese Patent CN107544426A only discloses an ideal theoretical scheme, for example, a parameter value representing the output shaft load and the slope value of the output shaft load are obtained to interrupt the torque output of the power tool. However, in fact, there are a lot of actual operating conditions that affect the average value and the slope value of the parameters representing the output shaft load. For example, during manual operation, the users use different degrees of forces to drive the screw into the workpiece, which has a great impact on a determination of a slope value of a current based on an output shaft of the power tool. Therefore, the preset position cannot be effectively recognized and a machine cannot be shut down accurately.

### SUMMARY

An example provides a power tool. The power tool includes an output shaft, a motor, a housing, a detection unit, a storage device and a control unit. The output shaft is configured to output a torsion. The motor is configured to drive the output shaft to rotate. The housing is configured to accommodate the motor. The detection unit is configured to detect an operational parameter of the power tool. The storage device is configured to store at least a first threshold corresponding to a first operating condition set and a second threshold corresponding to a second operating condition set. The control unit is communicatively connected to the detection unit and the storage device, or the control unit is configured to establish a functional relationship f(x, y, M) so as to drive the motor to operate in different operation modes. x is first feature data, and the first feature data is any one of a certain operational parameter, a first derivative of the certain operational parameter, or a second derivative of the certain operational parameter. y is second feature data, and the second feature data is any one of another operational parameter, a first derivative of the another operational parameter, or a second derivative of the another operational parameter. M is a matched first operation mode or a matched second operation mode. The control unit is further configured to: when the power tool is working, determine the first operating condition set among a plurality of operating condition sets through the first feature data and the second feature data obtained through an analysis of the detected operational parameter of the power tool, where the first operating condition set matches the first threshold; and in response to detected data reaching the first threshold matching the first operating condition set, determine that a fastener is close to being in contact with a bottom or drilling breakthrough, and control the power tool to operate in the first operation mode. The control unit is configured to determine the second operating condition set among the plurality of operating condition sets through an analysis of the first feature data and the second feature data of the power tool collected, where the second operating condition set matches the second threshold; and in response to the detected data reaching the second threshold matching the second operating condition set, determine that the fastener is close to being in contact with the bottom or the drilling breakthrough, and control the power tool to operate in the second operation mode.

In an example, the second operation mode is different from the first operation mode.

In an example, the intelligent tool system includes an adjustment assembly. The adjustment assembly is configured to switch the intelligent tool system to one or a combination of a woodworking mode, a metal mode, or a drill shift mode.

In an example, the power tool includes a transmission assembly. The adjustment assembly is connected to the transmission assembly, and the adjustment assembly is adjusted to switch to the woodworking mode, the metal mode, or the drill shift mode; the adjustment assembly drives the transmission assembly to make the power tool switch to an output speed interval corresponding to the woodworking mode, the metal mode, or the drill shift mode selected.

In an example, the adjustment assembly includes an adjustment cup. The adjustment cup is configured to switch between the woodworking mode, the metal mode, and the drill shift mode of the power tool; the transmission assembly includes a planetary gear set, a gearbox, and a connecting rod; the planetary gear set is disposed inside the gearbox, and the connecting rod is connected to the adjustment cup and the planetary gear set. The connecting rod is disposed below the gearbox.

In an example, the woodworking mode is suitable for pinning the fastener into a wooden workpiece. The storage device is configured to store a first operating condition set, a second operating condition set, and an Nth operating condition set in the woodworking mode; the metal mode is suitable for pinning the fastener into a metal workpiece, and the storage device is configured to store a first operating condition set, a second operating condition set, and an Nth operating condition set in the metal mode; the drill shift mode is suitable for drilling a workpiece, and the storage device is configured to store a first operating condition set, a second operating condition set, and an Nth operating condition set in the drill shift mode.

In an example, the first operating condition set or the second operating condition set includes at least two or more operating conditions.

In an example, the control unit is configured to detect the first feature data and/or the second feature data of the power tool acting on a workpiece for first N seconds and analyze and determine an operating condition set type in a current operation mode.

In an example, the first threshold matching the first operating condition set includes a threshold of the second feature data, and the control unit is configured to control the power tool into the first operation mode in response to the second feature data being detected to reach the first threshold.

In an example, the first threshold matching the first operating condition set includes a threshold of the first feature data and a threshold of the second feature data, and the control unit is configured to control the power tool into the first operation mode in response to the first feature data and the second feature data being detected to reach the first threshold.

In an example, the first feature data is a current of the power tool and the second feature data is a current slope value of the power tool.

In an example, the first feature data is a voltage of the power tool and the second feature data is a voltage slope value of the power tool.

In an example, the power tool analyzes an operating condition type of the intelligent tool system according to a cluster analysis algorithm.

In an example, the second feature data is a first or second derivative of the first feature data.

An example provides a control method of the power tool. The control method includes: starting the power tool and detecting the operational parameter of the power tool to analyze and obtain the first feature data and the second feature data so as to determine the first operating condition set or the second operating condition set among the plurality of operating condition sets, where the first operating condition set matches the first threshold and the second operating condition set matches the second threshold; acquiring the first threshold corresponding to the first operating condition set or the second threshold corresponding to the second operating condition set; in response to the detected data reaching the first threshold matching the first operating condition set, determining that the fastener is close to being in contact with the bottom or the drilling breakthrough, and control the power tool to operate in the first operation mode; and in response to the detected data reaching the second threshold matching the second operating condition set, determining that the fastener is close to being in contact with the bottom or the drilling breakthrough, and control the power tool to operate in the second operation mode.

In an example, the first feature data and the second feature data under different operating conditions are collected, and the different operating conditions are classified according to the first feature data and the second feature data and stored in the power tool.

An example provides a power tool. The power tool includes the output shaft, the motor, the housing, the detection unit, the storage device, and the control unit. The output shaft is configured to output the torsion. The motor is configured to drive the output shaft to rotate. The housing is configured to accommodate the motor. The detection unit is configured to detect an operational parameter of the power tool. The storage device is configured to store a plurality of thresholds corresponding to the plurality of operating condition sets and includes at least the first threshold corresponding to the first operating condition set and the second threshold corresponding to the second operating condition set. The control unit is electrically connected to or communicates with the detection unit and the storage device. Moreover, the control unit is configured to: when the power tool is working, determine the first operating condition set among the plurality of operating condition sets through an analysis of first feature data and/or second feature data obtained through an analysis of the detected operational parameter of the power tool, where the first operating condition set matches the first threshold; and in response to detected data reaching the first threshold matching the first operating condition set, determine that a fastener is close to being in contact with a bottom or drilling breakthrough, and control the power tool to operate in a first operation mode. The control unit is configured to: when the power tool is working, determine the second operating condition set among the plurality of operating condition sets through an analysis of a first feature value and/or a second feature value obtained through the analysis of the detected operational parameter of the power tool, where the second operating condition set matches the second threshold; and in response to the detected data reaching the second threshold matching the second operating condition set, determine that the fastener is close to being in contact with the bottom or the drilling breakthrough, and control the power tool to operate in a second operation mode.

In an example, the power tool includes at least the woodworking mode, the metal mode, and the drill shift mode. The woodworking mode is suitable for pinning the fastener into the wooden workpiece, and the storage device is configured to store the first operating condition set, the second operating condition set, and the Nth operating condition set in the woodworking mode; the metal mode is suitable for pinning the fastener into the metal workpiece, and the storage device is configured to store the first operating condition set, the second operating condition set, and the Nth operating condition set in the metal mode; the drill shift mode is suitable for drilling the workpiece, and the storage device is configured to store the first operating condition set, the second operating condition set, and the Nth operating condition set in the drill shift mode.

### BRIEF DESCRIPTION OF DRAWINGS

FIG. 1 is a perspective view of a power tool according to the present application;

FIG. 2 is an internal view of the power tool of FIG. 1;

FIG. 3 is an internal view of the power tool of FIG. 1 from another angle;

FIG. 4 is a sectional view of a head of the power tool of FIG. 1;

FIG. 5 is a block diagram of the power tool in FIG. 1;

FIG. 6 is a graph showing a variation of a parameter during operation of a power tool in a woodworking mode according to the present application;

FIG. 7 is a use flowchart of a power tool in a woodworking mode according to the present application;

FIG. 8 is a detection and classification method of an operating condition according to the present application;

FIG. 9 is a control logic diagram of a power tool according to the present application;

FIG. 10 is a use flowchart of a power tool in a metal mode according to the present application;

FIG. 11 is a graph showing a variation of a parameter during operation of a power tool in a drill shift mode according to the present application;

FIG. 12 is a use flowchart of a power tool in a drill shift mode according to the present application;

FIG. 13 is a structure view of a power tool according to the present application; and

FIG. 14 is a control logic diagram of a power tool according to the present application.

### DETAILED DESCRIPTION

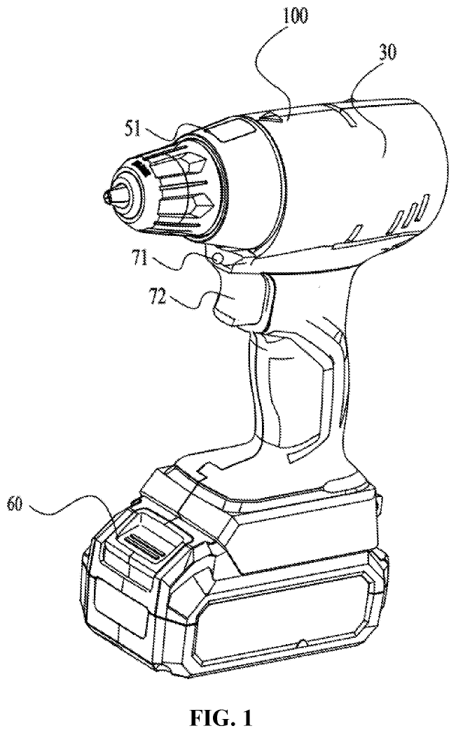

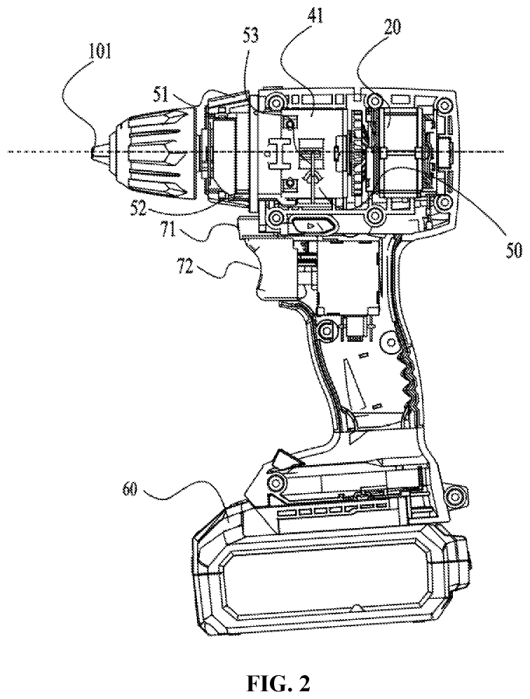

Referring to FIGS. 1 and 2, in a first implementation of the present application, a power tool 100 is provided. The power tool 100 is an impact-type tool such as a drill and an impact drill, and the power tool 100 is used for applying a fastener to a workpiece or directly acting on a workpiece to punch. The power tool 100 includes a motor 20, an output shaft 10 and a switch 72. The switch 72 controls on and off of the motor 20. The motor 20 drives the output shaft 10 to rotate around a first axis 101 and outputs a torsion through the output shaft 10. The power tool 100 further includes a transmission assembly 40 and a housing 30. The transmission assembly 40 is connected to the motor 20 and the output shaft 10. The housing 30 is configured to accommodate the motor 20, the transmission assembly 40 and the like, and the housing 30 forms a grip for users to hold. The output shaft 10 is connected to a tool chuck. The tool chuck is configured for detachably mounting a tool attachment so as to match fasteners of different sizes. The fastener may be a connecting tool such as a screw.

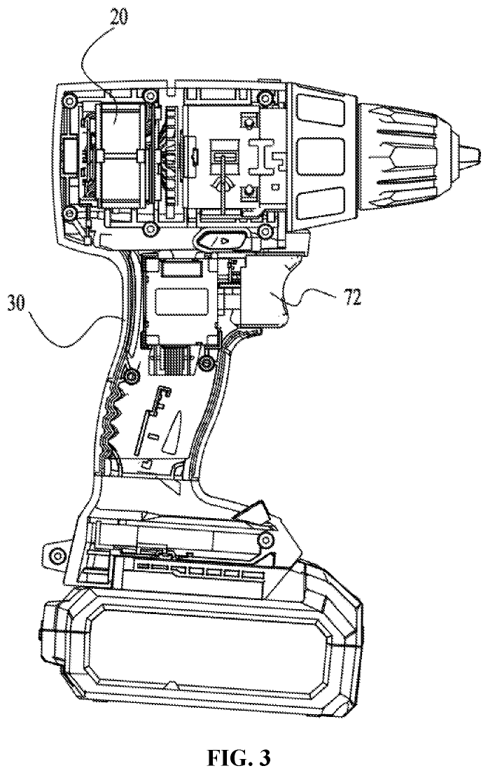

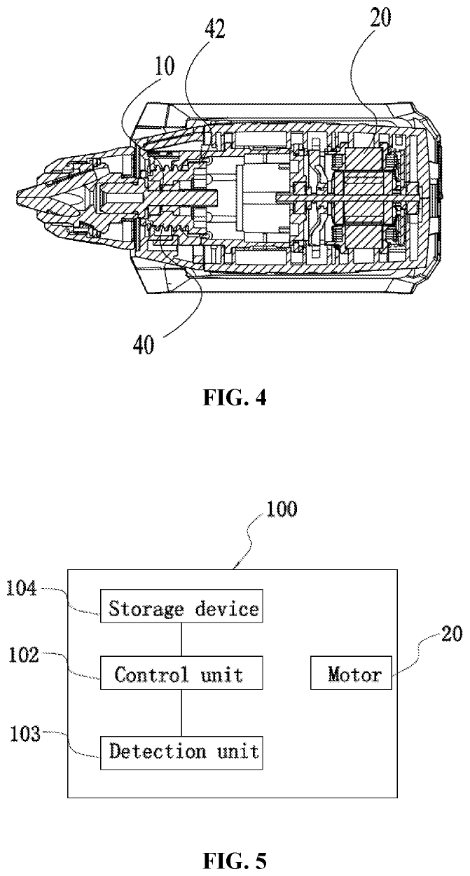

Referring to FIGS. 1 to 5, the power tool 100 includes a detection unit 103 and an adjustment assembly 50. The detection unit 103 is configured to detect an operational parameter of the power tool 100, such as current. The adjustment assembly 50 is configured to control an operation mode of the power tool 100, such as a woodworking mode, a metal mode, and a drill shift mode. The power tool 100 further includes a control unit 102 configured to control operation of the power tool 100. The control unit 102 controls the operation of the power tool 100 according to the operation mode and the operational parameter of the power tool 100 detected by the detection unit 103. The control unit 102 controls the power tool 100 to decelerate at a predetermined speed or stop the operation when the fastener acted by the power tool 100 is in contact with a bottom, or the control unit 102 controls the power tool 100 to decelerate at the predetermined speed or stop the operation when the power tool 100 performs drill-through.

The power tool 100 is implemented as a two-speed power tool 100 or a multi-speed power tool 100. The two-speed power tool 100 corresponds to a high output rotational speed and a low output rotational speed. The multi-speed power tool 100 includes multiple output rotational speeds. The adjustment assembly 50 is connected to the transmission assembly 40, and an output rotational speed or an output rotational speed interval of the power tool 100 is switched by the adjustment assembly 50.

Referring to FIG. 2, a configuration for switching the output rotational speed is provided. Taking the two-speed power tool 100 as an example, the transmission assembly 40 includes a gear set and a gearbox 41, and a connecting rod 52 connected to the transmission assembly 40 is also provided. The transmission assembly 40 includes a planetary gear set 42 and the gearbox 41. Optionally, the planetary gear set 42 is disposed in the gearbox 41 and is packaged by the gearbox 41. The planetary gear set 42 includes a speed regulation gear, a first gear, and a plurality of second gears. The plurality of second gears form a planetary gear structure with the first gear. The first gear serves as a sun gear, and the plurality of second gears as planetary gears are meshed with the sun gear. The speed regulation gear is meshed with the first gear and the plurality of second gears separately from the outside and is slidable on the first gear and the plurality of second gears. Therefore, the speed regulation gear is meshed with the plurality of second gears separately or the speed regulation gear is meshed simultaneously with the first gear and the plurality of second gears so as to switch an output speed of the output shaft.

The adjustment assembly 50 adjusts a reduction ratio of the planetary gear set 42 by controlling a position of the speed regulation gear. The adjustment assembly 50 further includes an adjustment cup 51 and the connecting rod 52 directly connected to the adjustment cup 51. The adjustment cup 51 is implemented in a shape of a cup and is rotatably connected to an end of the housing 30. Moreover, the adjustment cup 51 is connected to the transmission assembly 40 and configured to control a transmission ratio of the transmission assembly 40 so as to adjust the rotational speed of the power tool 100. The connecting rod 52 can be driven to rotate inside the housing 30 as the adjustment cup 51 rotates. The adjustment assembly 50 further includes a connector connected to the speed regulation gear. An end of the connecting rod 52 is connected to the adjustment cup 51, and another end of the connecting rod 52 is connected to the connector. Moreover, the connecting rod 52 is engaged to planes or surfaces having different heights, so that when the connecting rod 52 rotates with the adjustment cup 51, the connecting rod 52 is limited by the planes or the surfaces having different heights to move back and forth along the first axis 101 so as to drive the speed regulation gear to slide relatively.

In another implementation, the adjustment assembly 50 includes an adjustment key and has the connecting rod 52 connected to the adjustment key. The connecting rod 52 is driven by the adjustment key to have displacement. The adjustment assembly 50 further includes the connector connected to the speed regulation gear. The connecting rod 52 is connected to the connector and the adjustment key. The users select the output rotational speed by toggling the adjustment key.

The connecting rod 52 below the gearbox 41 is hidden inside a machine body. Compared with the connecting rod 52 being above the gearbox 41 of other drills, the connecting rod 52 being below the gearbox 41 makes a structure above the machine body reduced, the machine body more slender, and a distance from the output shaft 10 to a top of the machine body reduced, increasing the working range of the drill. Moreover, a mode display and a shift structure are both placed in the adjustment cup 51 in the middle of the machine body. The users simply need to pay attention to and adjust a required mode and do not need to pay attention to a high or low speed shift, facilitating operation. The mode display structure and the connecting rod 52 are at a relative position on a circumference of the adjustment cup 51, which facilitates an arrangement of the two structures and reduces an assembly cost.

The power tool further includes a reverse switch 71 controlling forward rotation and reverse rotation of the motor. The reverse switch 71 is disposed close to the switch 72, and the reverse switch 71 is disposed directly in front of the grip of the power tool so that a pressing direction of the reverse switch and a first axis are parallel, thereby facilitating operation of the power tool by the users.

The control unit 102 includes at least a driver circuit and a control element. The control element is connected to the driver circuit, and the control element may be a circuit board or a single-chip microcomputer. The control element stores an algorithm for operation of the power tool 100 and is connected to the motor 20 through the driver circuit. Moreover, the control element adjusts the rotational speed and other operation states of the power tool 100 by controlling a voltage and other parameters of the motor 20. In an example of the present application, the power tool 100 further includes a power supply. The power supply is connected to the driver circuit. Optionally, the power supply is one or more battery packs 60, and the battery pack 60 is pluggable relative to the power tool 100.

The power tool 100 has one or more operation modes. The operation mode includes at least the woodworking mode. The adjustment assembly 50 can adjust the operation mode. The adjustment cup 51 or the adjustment key is used for the users to adjust the operation mode. Different operation modes correspond to different rotational speeds, that is, the users select the operation mode such as the woodworking mode through the adjustment cup 51 or the adjustment key. The adjustment key or the adjustment cup 51 moves the transmission assembly 40 through the connecting rod 52 to change the transmission ratio of the transmission assembly 40 adjusts the operation mode of the power tool 100, and switches to a corresponding output rotational speed. Under the woodworking mode, the output rotational speed is relatively low, and the detection unit 103 detects the current operation mode adjusted by the users and sends the current operation mode to the control unit 102. Alternatively, the operational parameter of the power tool 100 is detected by the detection unit 103, and one or more types of feature data are obtained by the control unit 102 through the analysis of the detected operational parameter of the power tool 100 to determine the operation mode or a certain type of operating condition set among a plurality of operating condition sets. Optionally, the power tool 100 includes an indicator light. A speed regulation cup or an adjustment key is linked to a switch of the indicator light to display the current operation mode through light and remind the users of a currently selected illumination state. The control unit 102 is configured to establish the functional relationship f(x, y, M) so as to drive the motor to operate in different operation modes. x is the first feature data, and the first feature data is any one of a certain operational parameter, the first derivative of the certain operational parameter, or the second derivative of the certain operational parameter. y is the second feature data, and the second feature data is any one of another operational parameter, the first derivative of the another operational parameter, or the second derivative of the another operational parameter. M is a matched first operation mode or a matched second operation mode. Here, the first feature data and the second feature data may be embodied in different forms of a same operational parameter, which is not limited herein.

The operation mode may include the woodworking mode. The woodworking mode is a mode of pinning the fastener into a wooden workpiece, and the woodworking mode includes different operating condition sets. The different operating condition sets are operating conditions in which different types of wooden workpieces match different types of screws. For example, the screw is driven into the wooden workpiece. In the woodworking mode, the operating condition sets are divided into a first operating condition set, a second operating condition set, and an Nth operating condition set. Different operating condition sets correspond to states in which different types of screws are pinned into different types of wooden workpieces, such as screws with different diameters and wooden workpieces made of different materials corresponding to different operating condition sets. In an example of the present application, the working of the wooden workpieces made of different materials and different screws are tested so that the parameters of the corresponding operating conditions are acquired. Then the parameters are classified through a cluster analysis or big data analysis and parameter intervals are obtained. The type of screw and the corresponding type of wooden workpiece which are in the same parameter interval are classified into a same operating condition, and the first operating condition set, the second operating condition set, and the Nth operating condition set are generated correspondingly. In the woodworking mode, at least two types of the first operating condition set and the second operating condition set are provided. In order to improve the accuracy of automatic stop of the power tool 100 in response to being in contact with the bottom, a plurality of operating conditions are configured. A method of statistical classification based on empirical data may also be adopted, which is not limited herein.

The control unit 102 includes a storage device 104. The storage device 104 is configured to store data and algorithms controlling automatic rotation stop of the power tool 100. The storage device 104 may be provided as a storage, the working of various types of fasteners and plates is tested in advance so that relevant parameters can be acquired, and the relevant parameters can be classified and corresponding parameters are stored in the storage device 104. In the test of screws and wooden workpieces acting on by the power tool 100, the first feature data and the second feature data for the first N seconds are acquired, different operating conditions are classified according to the first feature data and the second feature data, and a corresponding first feature data interval and a corresponding second feature data interval are obtained. That is, the first operating condition set includes all operating condition sets of the first feature data interval and the second feature data interval, such as the operating condition set in which various types of screws are pinned into a pine wood.

When the power tool 100 is working, the detected operational parameter of the power tool 100 is analyzed to obtain the first feature data and the second feature data so as to determine the first operating condition set among the plurality of operating condition sets. The first operating condition set matches the first threshold. When the detected data reaches the first threshold matching the first operating condition set, it is determined that the fastener is close to being in contact with the bottom, and the power tool 100 is controlled to operate in the first operation mode. The first operating mode is one of controlling automatic rotation stop or speed reduction of the power tool 100, voice reminder, or warning light reminder. The power tool 100 may be mounted with the indicator light or an alarm. The first feature data and the second feature data of the power tool 100 collected are analyzed to determine the second operating condition set among the plurality of operating condition sets. The second operating condition set matches the second threshold. When the detected data reaches the second threshold matching the second operating condition set, it is determined that the fastener is close to being in contact with the bottom or the drilling breakthrough, and the power tool 100 is controlled to operate in the second operation mode. The second operation mode is one of controlling automatic rotation stop of the power tool 100, the voice reminder, or the warning light reminder. The first threshold and the second threshold each are one of a point value, a discrete value, or an interval value. A form of the threshold corresponding to a different operating condition set may be set differently.

The detection unit 103 may be implemented as a current sensor, a voltage sensor, a Hall sensor, or the like. Moreover, the detection unit 103 is configured to detect the current and voltage of the power tool 100 and a rotational speed of the output shaft 10, thereby acquiring the first feature data and the second feature data when the power tool 100 is operating. Taking the current as an example, a first-type state data may be a current value of the motor 20 when the power tool 100 is operating, and a corresponding second-type state data may be a current slope value of the motor 20. Average current values and average current slope values for the first N seconds when the power tool 100 drives various types of screws into various types of wooden workpieces are tested and collected, and the average current values and the average current slope values are classified through a cluster analysis method. The first operating condition set, the second operating condition set and the Nth operating condition set are configured, and their respective average current values and average current slope values for the first N seconds are stored in the storage device 104. For actual operation, the current slope values and the current values of the power tool 100 for the first N seconds are obtained are weighted to obtain the average current slope value and the average current value for the first N seconds. Stored parameter intervals corresponding to different operating condition sets are retrieved to acquire an operating condition set type corresponding to the screw and the wooden workpiece in actual operation. Optionally, the first N seconds are set to the first 0.5 seconds.

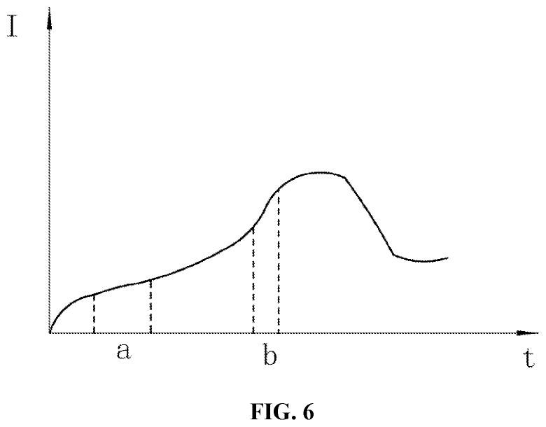

Before the power tool 100 is assembled, a corresponding current slope threshold is detected for many times in response to the fastener of the power tool 100 in a different operating condition set being in contact with the bottom, and the threshold is recorded in the storage device 104 of the power tool 100. When the power tool 100 is actually used to act on the fastener, the detection unit 103 detects the average current slope value and the average current value for first N seconds or a certain selected period of time during, and a current operating condition type is acquired by looking up a table or data comparison. That is, the first operating condition set, the second operating condition set, or the Nth operating condition set is specifically acquired. The detection unit 103 continues to detect the current slope value of the power tool 100. When the current slope value exceeds the current slope threshold corresponding to a current operating condition, it is determined that the screw is close to being in contact with the bottom or the screw is in contact with the bottom, that is, the working on the screw is completed. The control unit 102 performs control to enter the first operation mode. The first operation mode corresponding to the first operating condition set is determining the operation state after the screw is close to being in contact with the bottom or after the screw is in contact with the bottom. In the first operation mode, the power tool 100 stops rotating, or slows down, or slows down at a first speed. Referring to a trend of the first feature data in actual operation in FIG. 6, the first feature data and/or the second feature data during time period a is acquired, and a current operating condition type is acquired through looking up the table or calculation. Based on a corresponding threshold or a corresponding threshold interval in time period b acquired through the operating condition type determined in time period a to determine that the fastener is close to being in contact with the bottom or that the fastener is in contact with the bottom. In this case, the power tool 100 is controlled to operate in the first operation mode or the second operation mode. For example, the first operation mode may be operating at a first constant speed or may be continuously decelerating or discontinuously decelerating or stopping rotating; and the second operation mode may be operating at a second constant speed or may also be continuously decelerating or discontinuously decelerating or stopping rotating.

In some examples of the present application, the first threshold matching the first operating condition set includes a threshold of the second feature data, and the control unit 102 is configured to control the power tool 100 into the first operation mode in response to the second feature data being detected to reach the first threshold. For example, a corresponding threshold for the current slope is set as a criterion for determining whether the bottom is in contact. In some other examples of the present application, the first threshold matching the first operating condition set includes a threshold of the first feature data and the threshold of the second feature data, and the control unit 102 is configured to control the power tool 100 into the first operation mode in response to the first feature data and the second feature data being detected to reach the first threshold. That is, two feature values such as the current and the current slope can be respectively configured with corresponding thresholds, which is mainly based on consideration of different specific operating conditions. In an example, for the classification of the operating conditions of the power tool 100, in addition to setting the woodworking mode with the matching of a screw model and the wooden workpiece as classification objects, output power of the power tool 100, the output rotational speed of the power tool 100, an initial pressing degree of the users and the like which affect any first feature data and/or second feature data and the corresponding thresholds in response to final bottom contact may also be used. A principle is consistent with the principle of the above classification method and is not described here in detail.

For example, when the users adjust the operation mode to the woodworking mode and the power tool 100 works in the first operating condition set, the first operating condition set among the plurality of operating condition sets in the woodworking mode is determined through an analysis of the detected first feature data and/or second feature data. The first operating condition set matches the first threshold. When the detected data reaches the first threshold matching the first operating condition set in the woodworking mode, it is determined that the fastener is close to being in contact with the bottom, and the power tool 100 is controlled to operate in the first operation mode. When the users adjust the operation mode to the woodworking mode and the power tool 100 works in the second operating condition set, the second operating condition set among different operating condition sets in the woodworking mode is determined through an analysis of the detected first feature data and/or second feature data. The second operating condition set matches the second threshold. When the detected data reaches the second threshold matching the second operating condition set in the woodworking mode, it is determined that the fastener is close to being in contact with the bottom, and the power tool 100 is controlled to operate in the second operation mode.

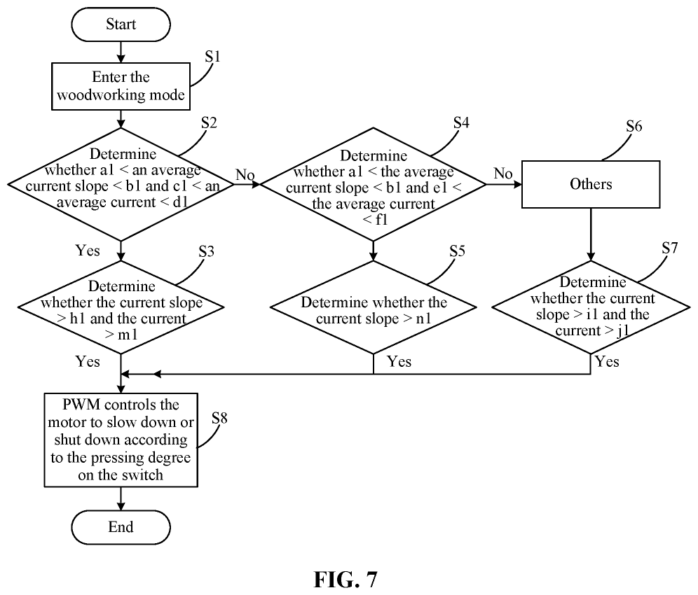

Taking the current value as the first feature data and the current slope value as the second feature data as an example, weighted average values of the first feature data and weighted average values of the second feature data in the first N seconds are acquired. Referring to FIG. 7, a use flowchart in the woodworking mode is provided. For example, three operating condition categories or three operating condition sets are provided. Step S1 is performed to enter the woodworking mode. Step S2 is performed to determine whether a1<an average current slope<b1 and c1<an average current<d1, which is a first major operating condition category or a first major operating condition set. If yes, step S3 is performed to determine whether the current slope>h1 and the current>m1. If yes, step S8 is performed in which PWM controls the motor 20 to slow down or shut down according to a pressing degree on the switch. If step S2 is determined to be no, step S4 is performed to determine whether a1<the average current slope<b1 and e1<the average current<f1, which is a second major operating condition category or a second major operating condition set. If yes, step S5 is performed to determine whether the current slope>n1. If yes, step S8 is performed in which PWM controls the motor 20 to slow down or shut down according to the pressing degree on the switch. If step S4 is determined to be no, step S6 is performed. S6 refers to a determination of other operating condition parameters, not limited to an certain interval range, which is a third major operating condition category or a third major operating condition set. The process proceeds until an interval of current first feature data of the power tool 100 is selected, and S6 is determined according to setting. If yes, step S7 is performed to determine whether the current slope>i1 and the current>j1. If yes, step S8 is performed in which PWM controls the motor 20 to slow down or shut down according to the pressing degree on the switch. The process ends after S8.

In an example of the present application, the second feature data is a first derivative of the first feature data or a second derivative of the first feature data. When the second feature data is set to be the second derivative of the first feature data, the state data of the power tool 100 in the different operating condition sets is detected for many times before assembly, so that a threshold or a threshold interval of the first feature data and the second derivative of the first feature data in response to the bottom is in contact are acquired and stored in the storage device 104. The threshold or the threshold interval of the first feature data and the second derivative of the first feature data are used as a determination reference condition when the power tool 100 is operating actually. In this manner, when acting on the fastener, the power tool 100 detects a completed state in time, and then the power tool 100 is controlled to stop rotating or rotate at a reduced speed, so as to prevent the workpiece from being damaged by excessive working and prevent the power tool 100 from being damaged. In the woodworking mode, the operational parameters of the power tool 100 for different types of screws and various wooden plates under different operating conditions are detected for many times, and data parameters of each operating condition set of the power tool 100 are acquired. The specific operating conditions are determined by the cluster analysis or the big data analysis during actual operation, and thresholds or threshold intervals of the first feature data and/or the second feature data or other state data corresponding to each operating condition set are stored. In this manner, a deviation of a parameter representing actual load of the output shaft of the power tool 100 acquired by the detection unit 103 or the control unit 102 when the users operate the power tool 100 with different degrees of force can be corrected or eliminated, so that a threshold parameter for determining the that the fastener is close to being in contact with the bottom corresponds to the current operating condition. Therefore, an accuracy of controlling the automatic stop of the power tool 100 is improved. For example, the accuracy of the automatic stop of the power tool 100 in the related art is about 20%, and the accuracy of the automatic stop of the power tool 100 in the implementation solution of the present application is greater than or equal to 80%. Therefore, a misjudgment that the power tool 100 is in contact with the bottom is reduced, thereby preventing stop by mistake from interfering with use of the users, and enhancing a use sense of the users.

In an example of the present application, the power tool 100 may adopt the cluster analysis algorithm in advance and store classification results in the storage device 104. Alternatively the cluster analysis algorithm is performed directly online to obtain the classification results. An example is provided below.

A plurality of pieces of collected data are divided into c ambiguity groups in the form of vectors, where c1, . . . , cc are cluster centers of the c ambiguity groups respectively. The cluster center of each group is calculated so that a minimum objective function of an objective function

$$J ( U , {c}_{1} , … , {c}_{c} ) = {\sum }_{i = 1}^{c} {J}_{i} = {\sum }_{i = 1}^{c} {\sum }_{j = 1}^{n} {u}_{ij}^{m} {d}_{ij}^{2} . \qquad ( 1 )$$

Here Uᵢⱼ is between 0 and 1, Cᵢ is the cluster center, and is an Euclidean cluster between an ith cluster center and a jth data point. Uᵢⱼ is a correction coefficient of dᵢⱼ, that is, a membership correction coefficient of a distance between the jth data point Xᵢ and the ith cluster center Cᵢ.

$${\sum }_{i = 1}^{c} {u}_{ij} = 1. m ∈ [ 1 , ∞ )$$

is a weighted index, and a convergence rate is affected by adjusting m.

An initialization cluster center is randomly set, and then an iterative process is performed for many times according to following formulas.

A new cluster center is calculated:

$${c}_{i} = \frac{{\sum }_{j = 1}^{n} {u}_{ij}^{m} {x}_{j}}{{\sum }_{j = 1}^{n} {u}_{ij}^{m}} . \qquad ( 2 )$$

A new U matrix is calculated:

$${u}_{ij} = \frac{1}{{\sum }_{k = 1}^{c} {( \frac{{d}_{ij}}{{d}_{kj}} )}^{2 \text{/} ( m - 1 )}} . \qquad ( 3 )$$

The process proceeds until converge to an optimal solution or a best solution; or the number of iterations is set to find a suboptimal solution close to the optimal solution, so as to find the classification of the operating conditions.

In another example of the present application, as shown in Table 1 below, an implementation of classification of operating conditions in the woodworking mode is provided. For example, the fastener is the screw. In the woodworking mode, related parameters of testing screws in different operating condition sets are collected in parallel. The above cluster analysis algorithm or other big data analysis algorithms can be adopted to classify the operating conditions, so as to achieve a function of the automatic stop when a screw is in contact with the bottom when the workpiece is the wooden workpiece in most operating conditions. As shown in the following table, the classification of the operating conditions can be roughly divided into four operating condition sets: a small screw 301, a medium screw 302, a first-type large screw 303, and a second-type large screw 304. A current slope interval and a current interval corresponding to the first N seconds and a sudden-change threshold of the current slope corresponding to being close to being in contact with the bottom or being in contact with the bottom are acquired, and above parameters are stored in the storage device 104. When the power tool 100 is used, the operation mode is adjusted to the woodworking mode through the adjustment assembly 50. In this case, the power tool 100 is operating at a speed corresponding to the woodworking mode, and the average current slope value and the average current value for the first N seconds are acquired through the detection unit 103. The current operating condition type is acquired through looking up the table or calculation so as to acquire the corresponding sudden-change threshold. A real-time current slope of the power tool 100 is detected. When the current slope is greater than the sudden-change threshold of a corresponding operating condition type, the power tool 100 is controlled to stop operating or rotate at a reduced speed.

TABLE 1

| | Current Slope | Current Interval | Sudden-change |
|---|---|---|---|
| | Interval | (A) | Threshold |
| Small Screw 301 | 0.018-0.045 | 48.7-65.4 | 0.14 |
| Medium Screw 302 | 0.037-0.069 | 72.2-78.6 | 0.35 |
| First-type Large | 0.165-0.183 | 126.2-145.5 | 1.47 |
| Screw 303 | | | |
| Second-type Large | 0.165-0.179 | 160-181 | 0.7 |
| Screw 304 | | | |

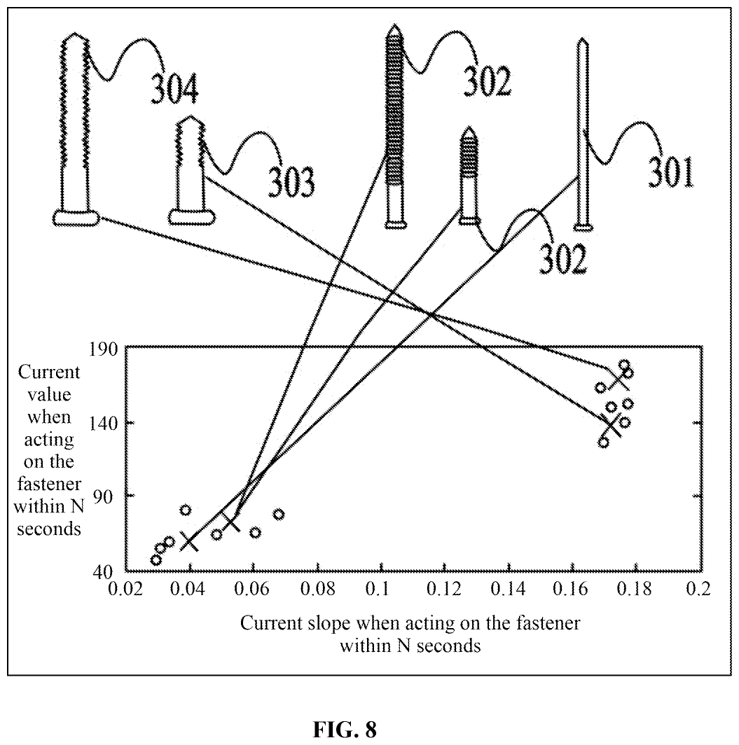

Referring to FIG. 8, in order to correspond to a schematic diagram of the four different operating condition sets in Table 1, a method of detecting and classifying the operating conditions according to the first feature data and/or the second feature data is provided. According to the detected current values and the detected current slope values of different screw types for wooden plates for the first N seconds, the operating conditions with the current value and/or the current slope value in the same interval are divided into a class, so as to classify the operating conditions and form different operating condition types or operating condition sets. In an example, the power tool 100 may be provided with two, three, four or more operating condition sets according to a specific operation mode of the power tool 100, which is not limited herein.

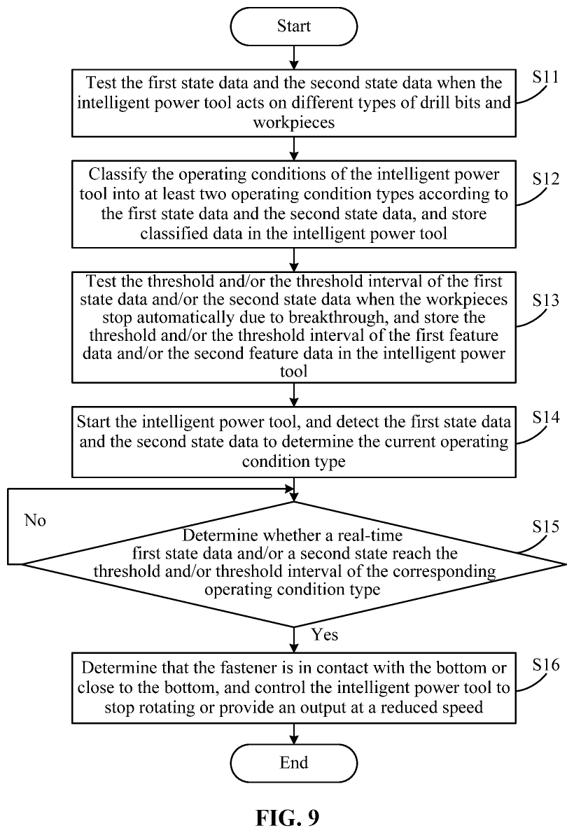

Referring to FIG. 9, a control method of the power tool 100 is provided. Step S11 is performed to test the first feature data and the second feature data when the power tool 100 acts on different types of drill bits and workpieces. Step S12 is performed to classify the operating conditions of the power tool 100 into at least two operating condition types according to the first feature data and the second feature data, and store classified data in the power tool 100. Step S13 is performed to test the threshold and/or the threshold interval of the first feature data and/or the second feature data when the fasteners of different operating conditions are close to the bottom or contact the bottom and stop automatically, and store the threshold and/or the threshold interval of the first feature data and/or the second feature data in the power tool 100. Step S14 is performed to start the power tool 100 and detect the first feature data and the second feature data to determine the current operating condition type. Step S15 is performed to determine whether a real-time first feature data and/or a second state reach the threshold and/or threshold interval of the corresponding operating condition type. Step S16 is performed to determine that the fastener is close to being in contact with the bottom or is in contact with the bottom and is performed to control the power tool 100 to stop rotating or provide an output at a reduced speed.

Optionally, as shown in FIG. 1, an adjustment assembly may be disposed on a mobile terminal. The mobile terminal and the power tool 100 are separately disposed and communicatively connected to each other.

Optionally, the first operating condition set or the second operating condition set includes two or more operating conditions. In some other examples of the present application, the first operating condition set or the second operating condition set may include one or more operating conditions, which is not limited herein. Further, in the above examples of the present application, a threshold may be set for a parameter representing an output shaft load of the power tool 100, for example, a threshold is set for the first feature data or the second feature data. Thresholds may also be set for at least two parameters representing an output load of the power tool 100, for example, corresponding thresholds are set for the first feature data and the second feature data, respectively. In this manner, the threshold can be controlled after one or more modes of the power tool 100 such as the woodworking mode, the metal mode, or the drill shift mode are classified. Moreover, the deviation of a parameter representing the actual load of the output shaft of the power tool 100 obtained by the detection unit 103 or the control unit 102 when users operate the power tool 100 with different degrees of force can be corrected or eliminated, so that an intelligent tool or an intelligent tool system can be more intelligent and accurately identify a predetermined position. Therefore, the accuracy of controlling the automatic stop of the power tool 100 is improved, and the misjudgment that the power tool 100 is in contact with the bottom is reduced, thereby preventing stop by mistake from interfering with use of users, and enhancing a user sense of uses. For some operating condition types, a threshold interval of relevant characteristic parameters need to be set, so that the deviation of the parameter representing the actual load of the output shaft of the power tool 100 obtained by the detection unit 103 or the control unit 102 when users operate the power tool 100 with different degrees of force can be better corrected or eliminated.

Optionally, the operation mode includes at least the metal mode. The adjustment assembly may adjust the operation mode, and an adjustment cup or the adjustment key may be used by users to adjust the operation mode. Different operation modes correspond to different rotational speeds. That is, users select the operation mode through the adjustment cup or intelligently determine the operation mode such as the metal mode according to a running program. The adjustment key or the adjustment cup moves a transmission assembly through a connecting rod to change the transmission ratio of the transmission assembly and adjusts the operation mode of the power tool 100 and switch to the corresponding output rotational speed. The detection unit 103 detects the current operation mode adjusted by users and sends the current operation mode to the control unit 102, or the control unit 102 directly perceives the operation mode of the power tool 100, such as the metal mode.

The metal mode is suitable for pinning the fastener into a metal workpiece, and the storage device 104 is configured to store the first operating condition set, the second operating condition set, and the Nth operating condition set in the metal mode. The control unit 102 is configured to: when the power tool 100 is working, determine the first operating condition set among the plurality of operating condition sets through the first feature data and/or the second feature data obtained through an analysis of the detected operational parameter of the power tool 100. The first operating condition set matches the first threshold. When the detected data reaches the first threshold matching the first operating condition set, it is determined that the fastener is close to being in contact with a bottom, and the power tool 100 is controlled to operate in the first operation mode. Similarly, the first operation mode may be operating at the first constant speed or may be continuously decelerating or discontinuously decelerating. The second operation mode may be operating at the second constant speed or may also be continuously decelerating or discontinuously decelerating. The first threshold and the second threshold each are one of the point value, the discrete value, or the interval value. The form of the threshold corresponding to a different operating condition set may be set differently.

The control unit 102 determines the second operating condition set among the plurality of operating condition sets through an analysis of the collected first feature data and the collected second feature data of the power tool 100. The second operating condition set matches the second threshold. When the detected data reaches the second threshold matching the second operating condition set, it is determined that the fastener is close to being in contact with the bottom, and the power tool 100 is controlled to operate in the second operation mode.

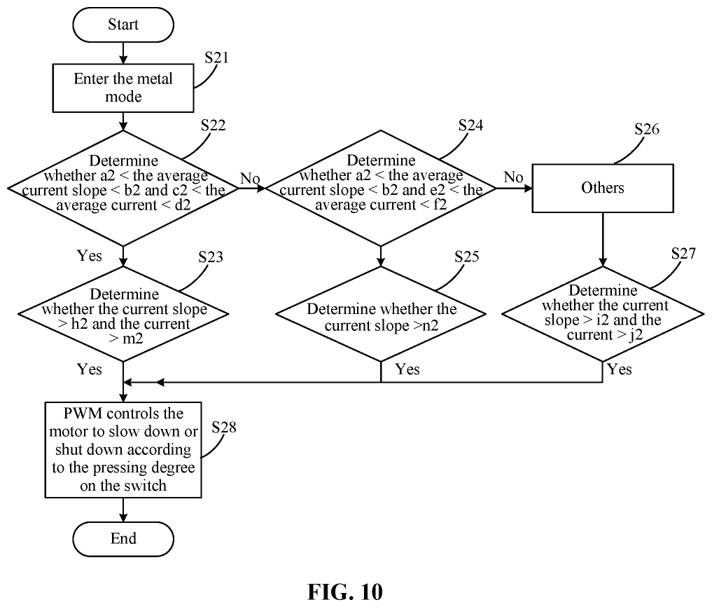

The metal mode is the mode of pinning the fastener into the metal workpiece, and the metal mode includes different operating condition sets. The different operating condition sets are operating conditions in which different types of metal workpieces match different types of screws. In some examples of the present application, the metal mode of the power tool 100 or an intelligent power system differs from the above-mentioned woodworking mode in that the first feature data and/or the second feature data and the corresponding threshold value are different. Moreover, the operating conditions of different types of metal workpieces matching different types of screws are classified into different operating conditions after the cluster analysis or the big data analysis. Referring to FIG. 10, a use flowchart in the metal mode is provided. Step S21 is performed to enter the metal mode. Step S22 is performed to determine whether a2<the average current slope<b2 and c2<the average current<d2. If yes, step S23 is performed to determine whether the current slope>h2 and the current>m2. If yes, step S28 is performed in which PWM controls the motor 20 to slow down or shut down according to the pressing degree on the switch. If step S22 is determined to be no, step S24 is performed to determine whether a2<the average current slope<b2 and e2<the average current<f2. If yes, step S25 is performed to determine whether the current slope>n2. If yes, step S28 is performed in which PWM controls the motor 20 to slow down or shut down according to the pressing degree on the switch. If step S4 is determined to be no, step S26 is performed. S26 refers to the determination of other operating condition parameters, not limited to a certain interval range. The process proceeds until the interval of the current first feature data of the power tool 100 is selected, and S26 is determined according to setting. If yes, step S27 is performed to determine whether the current slope>i2 and the current>j2. If yes, step S28 is performed in which PWM controls the motor 20 to slow down or shut down according to the pressing degree on the switch. The process ends after S28. Here, specific values of a2, b2, c2, d2, h2, m2, e2, f2, n2, i2, and j2 in the metal mode are different from specific values of a1, b1, c1, d1, h1, m1, e1, f1, n1, i1, and j1 in the woodworking mode.

For the classification of the operating conditions of the power tool 100, in addition to the types of the wooden workpiece and the metal workpiece as the classification objects, the screw types of the power tool 100 and other factors that affect the first feature data and/or the second feature data and the corresponding threshold in response to the bottom being in contact and automatic stop may also be the classification objects. The principle is generally consistent with the principle of the provided classification method and is not described in detail here.

The operation mode may further include at least the drill shift mode. The drill shift mode may be manually set through the adjustment assembly, thereby controlling the assembly to acquire that the current operation mode is in the drill shift mode. Alternatively, it may be determined that the operation mode needs to switch currently to the drill shift mode through an analysis according to a program operation of the first feature data and/or the second feature data, which is not limited herein.

The drill shift mode is an operation mode for a drill bit to break through the workpiece in response to drilling the workpiece. The drill shift mode includes different types of the operating conditions or different operating condition sets. The storage device 104 is configured to store a first operating condition set, a second operating condition set, and an Nth operating condition set in the drill shift mode. Different types of operating condition sets are operating conditions in which different types of workpieces match different types of screws. In an example, the drill shift mode of the power tool 100 or the intelligent power system differs from the above-mentioned woodworking mode in that the first feature data and/or the second feature data representing that the drill bit breaks through the workpiece and the corresponding threshold value are different and thus an interval division of values of different operating condition sets formed after the cluster analysis of the operating condition categories of different types of workpieces matching different types of screws is also different.

The control unit 102 is configured to: when the power tool 100 is working, determine the first operating condition set among the plurality of operating condition sets through the first feature data and the second feature data obtained through an analysis of the detected operational parameter of the power tool 100. The first operating condition set matches the first threshold. When the detected data reaches the first threshold matching the first operating condition set, the drilling breakthrough of the power tool 100 is determined, and the power tool 100 is controlled to operate in the first operation mode. Moreover, the control unit 102 is configured to determine the second operating condition set among the plurality of operating condition sets through an analysis of the first feature data and the second feature data of the power tool 100 collected. The second operating condition set matches the second threshold. When the detected data reaches the second threshold matching the second operating condition set, the drilling breakthrough of the power tool 100 is determined, and the power tool 100 is controlled to operate in the second operation mode. The first threshold and the second threshold each are one of the point value, the discrete value, or the interval value. The form of the threshold corresponding to a different operating condition sets may be set differently. The first operation mode may be operating at the first constant speed or may be continuously decelerating or discontinuously decelerating or stopping rotating. The second operation mode may be operating at the second constant speed or may also be continuously decelerating or discontinuously decelerating or stopping rotating. The first operation mode may be the same as the second operation mode or may be different from the second operation mode according to the operating condition. Here, “it is determined that the drill bit breaks through the workpiece” may refer to that when the drill bit is close to or near breaking through the workpiece, operation is performed in an appropriate first mode or second mode so that avoid adverse effects such as impact on users caused by excessive drilling stalls.

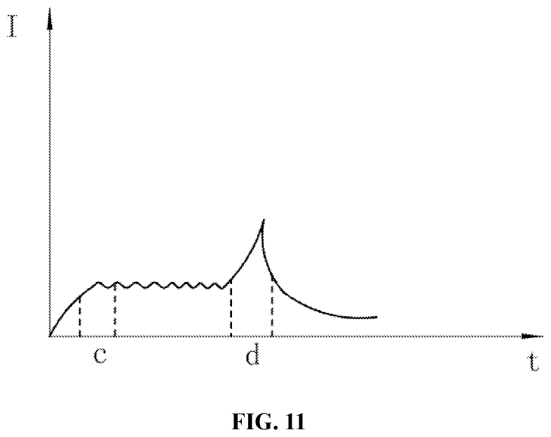

Referring to FIG. 11, in actual operation, the first feature data and/or the second feature data in time period c such as weighted average values of the current and the current slope are acquired by using the first feature date such as a trend of the current, and the current operating condition type is acquired through looking up the table or calculation. A corresponding threshold or a corresponding threshold interval in time period d is acquired based on the operating condition type determined in time period c to determine that the drill bit breaks through the workpiece. In this case, the power tool 100 is controlled to operate in the first operation mode or the second operation mode. For example, the first operation mode may be operating at the first constant speed or may be continuously decelerating or discontinuously decelerating; and the second operation mode may be operating at the second constant speed or may also be continuously decelerating or discontinuously decelerating.

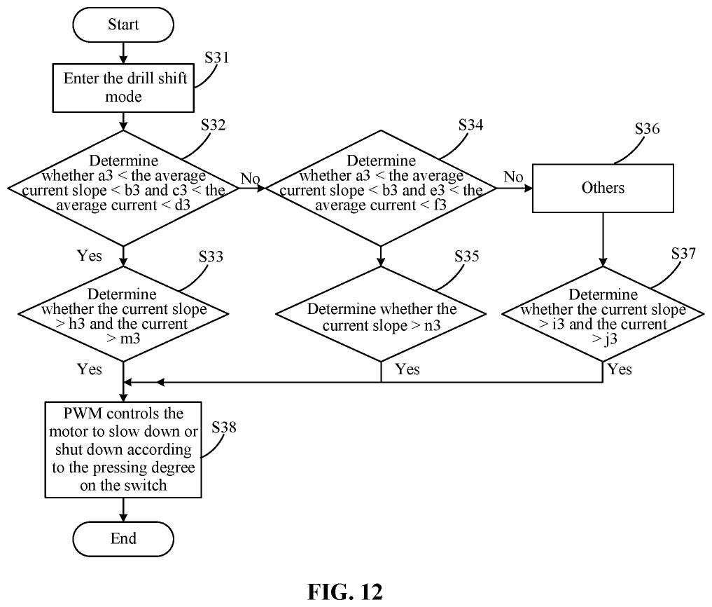

Referring to FIG. 12, a use flowchart in the drill shift mode is provided. Step S31 is performed to enter the drill shift mode. Step S32 is performed to determine whether a3<the average current slope<b3 and c3<the average current<d3. If yes, step S33 is performed to determine whether the current slope>h3 and the current>m3. If yes, step S38 is performed in which PWM controls the motor 20 to slow down or shut down according to the pressing degree on the switch. If step S32 is determined to be no, step S34 is performed to determine whether a3<the average current slope<b3 and e3<the average current<f3. If yes, step S35 is performed to determine whether the current slope>n3. If yes, step S38 is performed in which PWM controls the motor 20 to slow down or shut down according to the pressing degree on the switch. If step S34 is determined to be no, step S36 is performed. S36 refers to the determination of other operating condition parameters, not limited to a certain interval range. The process proceeds until the interval of the current first feature data of the power tool 100 is selected, and S36 is determined according to setting. If yes, step S37 is performed to determine whether the current slope>i3 and the current>j3. If yes, step S38 is performed in which PWM controls the motor 20 to slow down or shut down according to the pressing degree on the switch. The process ends after S38. Here, specific values of a3, b3, c3, d3, h3, m3, e3, f3, n3, i3, and j3 in the drill shift mode are different from specific values of a1, b1, c1, d1, h1, m1, e1, f1, n1, i1, and j1 in the woodworking mode.

In the above examples of the present application, the woodworking mode, the metal mode, or the drill shift mode may be an established mode set in the power tool 100 or the power tool 100 system or may be a certain segment program in a whole operation program or mode, which is not limited herein.

In a fourth implementation, the power tool 100 system can automatically determine or identify a certain operating condition set among the plurality of operating condition sets based on the detected first feature data and/or the detected second feature data. Moreover, the power tool 100 system determines whether the fastener is close to being in contact with the bottom or the drilling breakthrough according to the corresponding threshold so as to match an appropriate operation mode.

In some examples of the present application, the first operating condition set or the second operating condition set includes at least two or more operating conditions. In some other examples of the present application, the first operating condition set or the second operating condition set includes one or more operating conditions. One of the operating conditions refers to an operating condition in which a workpiece matches a screw. It may also be that a corresponding threshold interval may be set for an operating condition or an operating condition set, so that the deviation of the parameter representing the actual load of the output shaft of the power tool 100 obtained by the detection unit 103 or the control unit 102 when users operate the power tool 100 with different degrees of force can be corrected or eliminated. Therefore, the accuracy of controlling the power tool 100 to identify the predetermined position is improved, and the misjudgment of the power tool 100 is reduced, thereby preventing misjudgment from affecting the operation of users, and improving use experience.

In some examples of the present application, the control unit 102 may be configured to establish the functional relationship f(x, y, M) at least based on the first feature data and the second feature data so as to drive the motor 20 to operate in different matching modes. Moreover, the control unit 102 may also be configured to establish a functional relationship f(x, M), or f(y, M) based on the first feature data or the second feature data so as to drive the motor 20 to operate in the appropriate or an optimal operation mode. In summary, the power tool 100 or the power tool 100 system can automatically identify and enter a certain operation mode, such as the woodworking mode, the metal mode, or the drill shift mode, based on the first feature data and/or the second feature data, and enter a certain operating condition type or the certain operating condition set under the certain operation mode, which is not limited herein. Further, the above-mentioned manners are not only suitable for the case when the fastener is in contact with the bottom or the drilling breakthrough but also suitable for controlling other functions such as grinding and nailing, which is not limited herein.

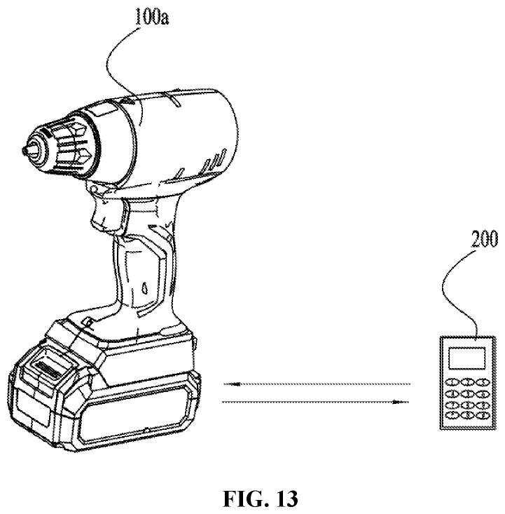

In the above-mentioned examples of the present application, the detection unit 103, the storage device 104, and the control unit 102 may be independent devices separated from each other or may also be integrated in a same chip and be an integrated unit with detection, storage, and control functions. Optionally, the detection unit 103, the storage device 104, and the control unit 102 may be disposed in an power tool 100a. Referring to FIG. 13, a part of the detection unit 103, the storage device 104, and the control unit 102 may be disposed in the power tool 100a, and another part may be disposed in an external terminal 200 such as a mobile phone. The external terminal 200 and the intelligent tool are electrically connected to or communicate with each other, which is not limited herein.

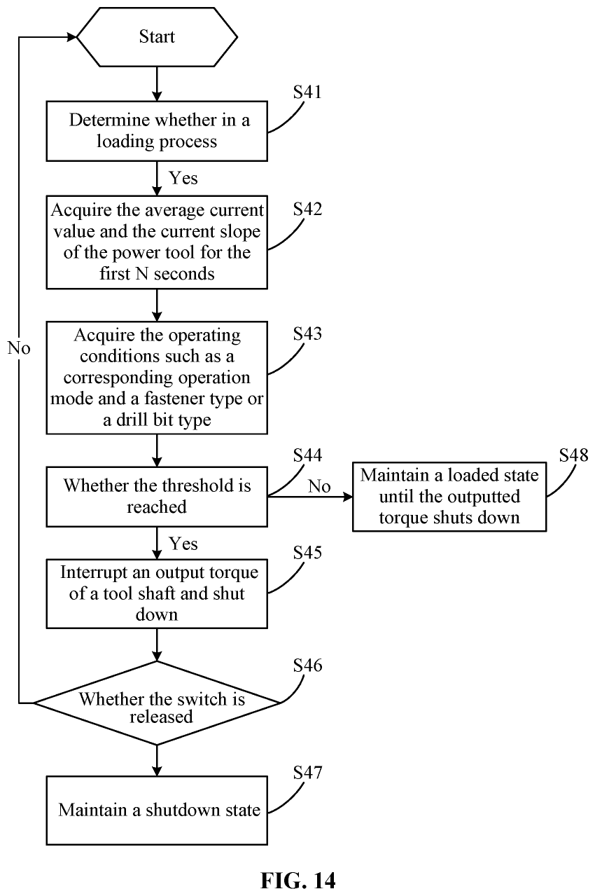

Referring to FIG. 14, a control method of the power tool 100 according to this example is provided. The power tool 100 is controlled to start. Step S41 is executed to determine whether the process is in a loading process. If yes, step S42 is executed to acquire the average current value and the current slope of the power tool 100 for the first N seconds. Step S43 is executed to acquire the operating conditions such as a corresponding operation mode, and a fastener type or a drill bit type. Step S44 is executed to determine whether the threshold is reached. If not, step S48 is executed to maintain a loaded state until the outputted torque shuts down. If the threshold is reached in step S44, step S45 is executed to interrupt an output torque of a tool shaft and shut down. Step S46 is executed to determine whether the switch is released. If yes, step S47 is executed to maintain a shutdown state. If not, the process is cyclically performed.

In an example, the control unit 102 may be selectively disposed outside the power tool 100, for example, in FIG. 1. Moreover, the control unit 102 may be communicatively connected to the power tool 100 and configured to analyze related parameters of the power tool 100 and control operation of the power tool 100.

What is claimed is:

1. A power tool, comprising:
an output shaft configured to output a torsion;
a motor configured to drive the output shaft to rotate;
a housing configured to accommodate the motor;
a detection unit configured to detect an operational parameter of the power tool;
a storage device configured to store a first threshold corresponding to a first operating condition set and a second threshold corresponding to a second operating condition set; and
a control unit communicatively connected to the detection unit and the storage device;
wherein the control unit is configured to establish a functional relationship f(x, y, M) so as to drive the motor to operate in different operation modes, x is first feature data, the first feature data is any one of a first operational parameter, a first derivative of the first operational parameter, or a second derivative of the first operational parameter, y is second feature data, the second feature data is any one of a second operational parameter, a first derivative of the second operational parameter, or a second derivative of the second operational parameter, and M is a first operation mode or a second operation mode;
wherein the control unit is configured to determine the first operating condition set among a plurality of operating condition sets through the first feature data and the second feature data obtained through an analysis of the detected operational parameter of the power tool and determine that a fastener is close to being in contact with a bottom or drilling breakthrough and control the power tool to operate in the first operation mode in response to detected data reaching the first threshold matching the first operating condition set; and
wherein the control unit is configured to determine the second operating condition set among the plurality of operating condition sets through an analysis of the first feature data and the second feature data of the power tool collected and determine that the fastener is close to being in contact with the bottom or the drilling breakthrough to control the power tool to operate in the second operation mode in response to the detected data reaching the second threshold matching the second operating condition set.

2. The power tool of claim 1, wherein the second operation mode is different from the first operation mode.

3. The power tool of claim 1, further comprising an adjustment assembly configured to switch the power tool to be in one or a combination of a woodworking mode, a metal mode, or a drill shift mode.

4. The power tool of claim 3, wherein the power tool further comprises a transmission assembly, the adjustment assembly is connected to the transmission assembly, the adjustment assembly is adjusted to switch to the woodworking mode, the metal mode, or the drill shift mode, and the adjustment assembly drives the transmission assembly to make the power tool switch to an output speed interval corresponding to the woodworking mode, the metal mode, or the drill shift mode selected.

5. The power tool of claim 4, wherein the adjustment assembly comprises an adjustment cup, the adjustment cup is configured to switch between the woodworking mode, the metal mode, and the drill shift mode of the power tool, the transmission assembly comprises a planetary gear set, a gearbox, and a connecting rod, the planetary gear set is disposed inside the gearbox, the connecting rod is connected to the adjustment cup and the planetary gear set, and the connecting rod is disposed below the gearbox.

6. The power tool of claim 3, wherein the woodworking mode is suitable for pinning the fastener into a wooden workpiece, the storage device is configured to store a first operating condition set, a second operating condition set, and an Nth operating condition set in the woodworking mode, the metal mode is suitable for pinning the fastener into a metal workpiece, the storage device is configured to store a first operating condition set, a second operating condition set, and an Nth operating condition set in the metal mode, the drill shift mode is suitable for drilling a workpiece, and the storage device is configured to store a first operating condition set, a second operating condition set, and an Nth operating condition set in the drill shift mode.

7. The power tool of claim 1, wherein the first operating condition set or the second operating condition set comprises at least two or more operating conditions.

8. The power tool of claim 1, wherein the control unit is configured to detect first feature data and/or second feature data of the power tool acting on a workpiece for first N seconds and analyze and determine an operating condition set type in a current operation mode.

9. The power tool of claim 1, wherein the first threshold matching the first operating condition set comprises a threshold of the second feature data and the control unit is configured to control the power tool into the first operation mode in response to the second feature data being detected to reach the first threshold.

10. The power tool of claim 1, wherein the first threshold matching the first operating condition set comprises a threshold of the first feature data and a threshold of the second feature data and the control unit is configured to control the power tool into the first operation mode in response to the first feature data and the second feature data being detected to respectively reach the first threshold.

11. The power tool of claim 1, wherein the first feature data is a current of the power tool and the second feature data is a current slope value of the power tool.

12. The power tool of claim 1, wherein the first feature data is a voltage of the power tool and the second feature data is a voltage slope value of the power tool.

13. The power tool of claim 1, wherein the power tool analyzes an operating condition type of the power tool according to a cluster analysis algorithm.

14. The power tool of claim 1, wherein the second feature data is a first or second derivative of the first feature data.

15. A control method for a power tool, the control method comprising:
detecting an operational parameter of the power tool to analyze and acquire a first feature data and a second feature data so as to determine a first operating condition set or a second operating condition set among a plurality of operating condition sets;
acquiring a first threshold corresponding to the first operating condition set or a second threshold corresponding to the second operating condition set;
in response to the detected operational parameter reaching the first threshold, determining that a fastener is close to being in contact with the bottom or the drilling breakthrough and controlling the power tool to operate in the first operation mode; and
in response to the detected operational parameter reaching the second threshold, determining that the fastener is close to being in contact with the bottom or the drilling breakthrough, and controlling the power tool to operate in the second operation mode.

16. The control method of claim 15, wherein first feature data and second feature data under different operating conditions are collected and the different operating conditions are classified according to the first feature data and the second feature data and stored in the power tool.

17. A power tool, comprising:
an output shaft configured to output a torsion;
a motor configured to drive the output shaft to rotate;
a housing configured to accommodate the motor;
a detection unit configured to detect an operational parameter of the power tool;
a storage device configured to store a plurality of thresholds corresponding to a plurality of operating condition sets and comprising at least a first threshold corresponding to a first operating condition set and a second threshold corresponding to a second operating condition set; and
a control unit electrically connected to or communicating with the detection unit and the storage device;
wherein the control unit is configured to determine the first operating condition set among the plurality of operating condition sets through an analysis of first feature data and/or second feature data obtained through an analysis of the detected operational parameter of the power tool and determine that a fastener is close to being in contact with a bottom or drilling breakthrough and control the power tool to operate in a first operation mode in response to detected data reaching the first threshold matching the first operating condition set; and
wherein the control unit is configured to determine the second operating condition set among the plurality of operating condition sets through an analysis of a first feature value and/or a second feature value obtained through the analysis of the detected operational parameter of the power tool and determine that the fastener is close to being in contact with the bottom or the drilling breakthrough and control the power tool to operate in a second operation mode in response to the detected data reaching the second threshold matching the second operating condition set.

18. The power tool of claim 17, comprising the power tool is operable in one or a combination of a woodworking mode, a metal mode, or a drill shift mode, the woodworking mode is suitable for pinning the fastener into a wooden workpiece, the storage device is configured to store a first operating condition set, a second operating condition set, and an Nth operating condition set in the woodworking mode, the metal mode is suitable for pinning the fastener into a metal workpiece, the storage device is configured to store a first operating condition set, a second operating condition set, and an Nth operating condition set in the metal mode, the drill shift mode is suitable for drilling a workpiece, and the storage device is configured to store a first operating condition set, a second operating condition set, and an Nth operating condition set in the drill shift mode.

19. The power tool of claim 17, further comprising a transmission assembly and an adjustment assembly, wherein the adjustment assembly is connected to the transmission assembly, the adjustment assembly is adjusted to switch to a woodworking mode, a metal mode, or a drill shift mode, and the adjustment assembly drives the transmission assembly to make the power tool switch to an output speed interval corresponding to the woodworking mode, the metal mode, or the drill shift mode selected.

20. The power tool of claim 17, wherein the first feature data is a current of the power tool and the second feature data is a current slope value of the power tool.
